(19) United States
(12) Patent Application Publication
(10) Pub. No.: US 2008/0143999 A1
(43) Pub. Date: Jun. 19, 2008

(54) Range finder and range finding method

(76) Inventor: Liu Wen-YU, R.O.C. (TW)

Correspondence Address: Raymond Sun, 12420 Woodhall Way, Tustin, CA, 92782, US

(21) Appl. No.: 11/901,757

(22) Filed: Sep. 19, 2007

(30) Foreign Application Priority Data
Dec. 15, 2006 (TW) 95147306

(51) Int. Cl. G01C 3/08

(52) U.S. Cl. 356/5.01

(57) ABSTRACT

A laser ranger has a rotational light source and a receiver. The rotational light source is used to provide a light beam with a pre-determined rotation speed. The receiver detects the time period for the light beam to travel from a first position to a second position of the receiver, such that the distance between the rotational light source and the receiver is calculated based on the detected time period and the spacing between the first and second positions of the receiver.

### BACKGROUND OF THE INVENTION

1. Field of the Invention

The present invention relates to a range finder, and in particular, to a laser range finder and a range finding method that uses a receiver to detect a light beam transmitted from a rotational light source, and which then calculates the distance between the receiver and the rotational light source.

2. Description of the Related Art

With the rapid development in semiconductor technology, the semiconductor laser has been widely used as various laser levels in construction and decoration works for performing leveling functions. For example, the single-axle rotary laser level with an electronic horizontal sensor can provide rotational laser beams on the horizontal plane, and in turn project a horizontal line on a wall under construction for reference, thereby making it a very popular auxiliary measurement device.

During construction and decoration works, the marking of distance (apart from the leveling operation) has been one of the most frequently encountered requirements. Therefore, there is a need for a laser level that can provide a rotational laser beam that can be used for range finding during measurement works.

### SUMMARY OF THE INVENTION

It is an objective of the present invention is to provide a laser range finder and a range finding method that can be used in a laser level to measure distances.

In order to accomplish the objects of the present invention, the present invention provides a laser range finder having a rotational light source and a receiver.

The rotational light source is used to provide a light beam with a pre-determined rotation speed. The receiver detects the time period for the light beam to travel from a first position to a second position of the receiver, such that the distance between the rotational light source and the receiver is calculated based on the detected time period and the spacing between the first and second positions of the receiver.

It is another object of the present invention to provide a range finding method which can be used to measure the distance between, for example, the rotational light source and the receiver. According to the method, a light beam with a pre-determined rotation speed is emitted by a rotational light source, the time period for the light beam traveling from the first position to the second position of the receiver is then detected, and the distance between the rotational light source and the receiver is then calculated based on the detected time period and the spacing of the first and second positions of the receiver.

### BRIEF DESCRIPTION OF THE DRAWINGS

FIG. 1 is an exploded perspective view of a range finder in accordance with one preferred embodiment of the present invention.

FIG. 2 is a block diagram of the circuit of the receiver in the range finder of FIG. 1.

### DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

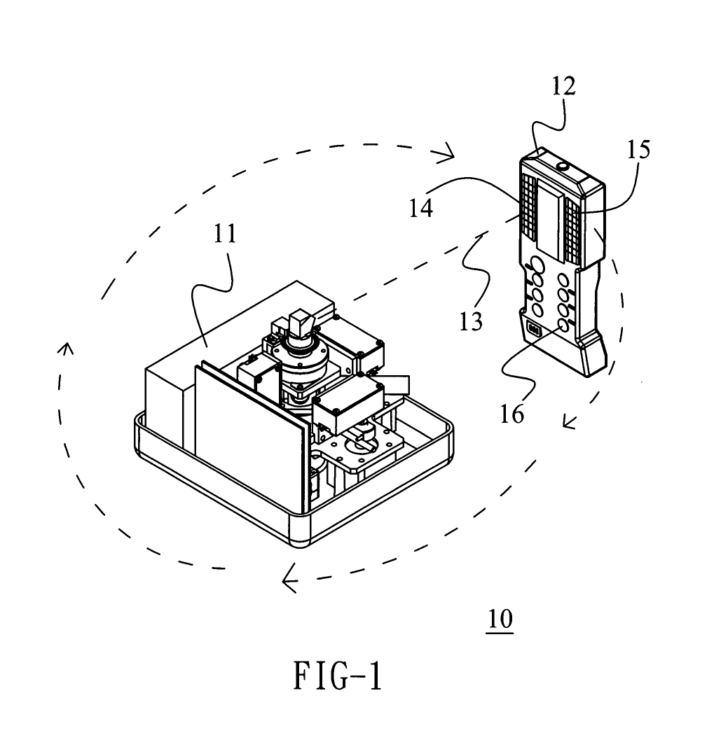

FIG. 1 illustrates a range finder 10 in accordance with a preferred embodiment of the present invention. The range finder 10 is built on a single-axle rotary laser level 11 and its receiver 12, such that the range finder 10 not only provides a rotational laser beam 13 that projects a horizontal reference line on a construction wall for auto-leveling, but also measures distances. The receiver 12 includes a remote control circuit 16 which can be used control the rotation speed, for example, of the single-axle rotary laser level 11, and therefore function as a remote controller for the single-axle rotary laser level 11.

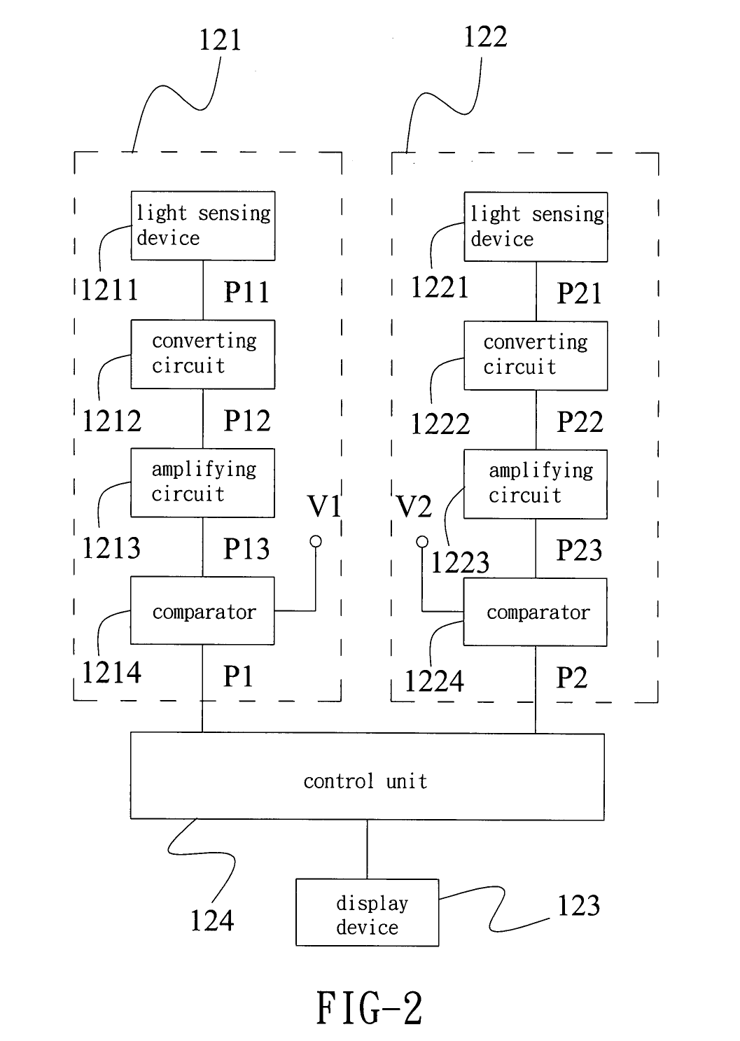

Referring to FIG. 1, the single-axle rotary laser level 11 may be used as a rotational light source to provide a laser beam 13 with a pre-determined rotation speed, and the receiver 12 is used to detect the time period for the light beam 13 to rotate from the first position 14 to the second position 15 of the receiver 12. The distance between the receiver 12 and the single-axle rotary laser level 11 can be calculated using this detected time period and the spacing between the first position 14 and second position 15. The operation principle of the range finder 10 will be explained with respect to the block diagram of the circuit of the receiver 12 shown in FIG. 2.

Referring to FIG. 2, the receiver 12 includes receiving circuits 121 and 122, a display device 123, and a control unit 124. The receiving circuit 121 has a light sensing device 1211, a converting circuit 1212, an amplifying circuit 1213, and a comparator 1214, while the receiving circuit 122 has a light sensing device 1221, a converting circuit 1222, an amplifying circuit 1223, and a comparator 1224. The display device 123 can be, for example, a liquid crystal display module. The control unit 124 can be embodied in the form of a microprocessor.

In FIG. 2, the light sensing device 1211, which can be embodied in the form of a photosensor, is used to receive the laser beam 13 at the first position 14 of the receiver 12 and to output a current signal P11 upon receipt of the laser beam 13. The converting circuit 1212 is coupled with the light sensing device 1211 to convert the current signal P11 to a voltage signal P12. The amplifying circuit 1213 is coupled with the converting circuit 1212 to amplify the voltage signal P12 to an amplified voltage signal P13. The comparator 1214 is coupled with the amplifying circuit 1213 to compare the amplified voltage signal P13 with a reference voltage V1 so as to output an electric signal P1 that indicates the detection of the laser beam 13.

Similarly, the light sensing device 1221, which can be embodied in the form of a photosensor, is used to receive the laser beam 13 at the second position 15 of the receiver 12 and to output a current signal P21. The converting circuit 1222 is coupled with the light sensing device 1221 to convert the current signal P21 to a voltage signal P22. The amplifying circuit 1223 is coupled with the converting circuit 1222 to amplify the voltage signal P22 to an amplified voltage signal P23. The comparator 1224 is coupled with the amplifying circuit 1223 to compare the amplified voltage signal P23 with a reference voltage V2 so as to output an electric signal P2 that indicates the detection of the laser beam 13.

The control unit 124 is coupled to the comparators 1214 and 1224 and the display device 123 to calculate and obtain the distance between the receiver 12 and the single-axle rotary laser level 11 using the received electric signals P1 and P2, and the distance obtained is then displayed on the display device 123. If the rotation speed of the laser beam 13 transmitted from the single-axle rotary laser level 11 is n per second, the following equations can be used:

ω=2πn

υ=rω=2πnr

υ=2πnr≈d/t

r≈d/(2πnt)

wherein ω is the angular velocity of the laser beam 13, n is the rotation speed of the laser beam 13, υ is the tangent velocity of the laser beam 13, r is the distance to be determined, d is the known spacing between the light sensing device 1211 and light sensing device 1221, and t is the time period detected.

Alternatively, the following equations can also be used for calculation:

ω=2πn

θ=ωt=2πnt

S=rθ=2πntr≈d

r≈d/(2πnt)

wherein ω is the angular velocity of the laser beam 13, n is the rotation speed of the laser beam 13, θ is the angular displacement of the laser beam 13, S is the arc length of the angular displacement θ of the laser beam 13, r is the distance to be determined, d is the spacing between the light sensing device 1211 and light sensing device 1221, and t is the time period detected.

The determined distance r is an estimated value that has a certain built-in error resulting from the calculations described above. If more precise results are required, additional parameters are needed for calibration.

Thus, the present invention provides a range finding method for measuring the distance between the single-axle rotary laser level 11 and a receiver 12. The range finding method provides a light beam with a pre-determined rotation speed from a rotational light source, and the time period is detected for the light beam rotating from the first position to the second position of the receiver, with the distance between the rotational light source and the receiver 12 calculated based on the detected time period and the spacing between the first and second positions of the receiver.

While the description above refers to particular embodiments of the present invention, it will be understood that many modifications may be made without departing from the spirit thereof.

What is claimed is:

1. A range finder, comprising
a rotational light source which provides a light beam having a predetermined rotation speed; and
a receiver aligned with the light source, the receiver having a first position, a second position, and a spacing between the first and second positions, the receiver detecting the time period for the light beam to travel from the first position to the second position on the receiver, such that the distance between the rotational light source and the receiver is calculated based on the time period and the spacing between the first and second positions of the receiver.

2. The range finder of claim 1, wherein the receiver comprises:
a first receiving circuit that receives the light beam at the first position and outputs an electric signal indicating the detection of the light beam;
a second receiving circuit that receives the light beam at the second position and outputs an electric signal indicating the detection of the light beam;
a display device; and
a control unit coupled with the first and second receiving circuits and the display device to receive the electric signals output from the first and second receiving circuits, and to calculate and obtain the distance, which is then displayed on the display device.

3. The range finder of claim 2, wherein each of the first and second receiving circuits comprises:
a light sensing device that receives the light beam and outputs a current signal;
a converting circuit coupled with the light sensing device, and which converts the current signal from the light sensing device to a voltage signal;
an amplifying circuit coupled with the converting circuit to amplify the voltage signal; and
a comparator coupled with the amplifying circuit to compare the amplified voltage signal with a reference voltage, and to output an electric signal indicating the detection of the light beam.

4. The range finder of claim 2, wherein the display device is a liquid crystal display module.

5. The range finder of claim 2, wherein the control unit is a microprocessor.

6. The range finder of claim 1, wherein the rotational light source is an auto-leveling laser level.

7. The range finder of claim 6, wherein the receiver further comprises a remote control circuit to remotely control the operation of the laser level.

8. The range finder of claim 1, wherein the light beam rotates from the first position to the second position.

9. A range finding method for detecting the distance between a rotational light source and a receiver, the receiver having first and second positions and a spacing between the first and second positions, comprising the steps:
emitting a light beam having a pre-determined rotation speed from the rotational light source;
detecting the time period required for the light beam to travel from the first position to the second position at the receiver; and
calculating the distance between the rotational light source and the receiver based on the detected time period and the spacing of the first and second positions of the receiver.

10. The method of claim 9, further comprising the step of displaying the distance.

11. The method of claim 9, wherein the light beam is a laser beam.

12. The method of claim 9, wherein the light beam rotates from the first position to the second position.
